(19) United States
(12) Patent Application Publication
(10) Pub. No.: US 2008/0278404 A1
(43) Pub. Date: Nov. 13, 2008

(54) Worm Gear Elevation Adjustment of a Parabolic Dish

(75) Inventors: E. Mitchell Blalock, Atlanta, GA (US); Wayne Holt, Dacula, GA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 11/747,130

(22) Filed: May 10, 2007

(51) Int. Cl. H01Q 3/08; H01Q 1/12

(52) U.S. Cl. 343/882

(57) ABSTRACT

According to the invention, a system for changing the elevation angle of a parabolic antenna is disclosed. The system may include a support member, a first gear set, and a first rotational motion source. The first gear set may include a worm gear and a first worm. The first worm may engage the worm gear which may have a substantially horizontal axis. The support member and the parabolic antenna may be operably coupled with the first gear set. The first rotational motion source may be operably coupled with the first worm, and the parabolic antenna may rotate about the substantially horizontal axis when the first rotational motion source is active.

### BACKGROUND OF THE INVENTION

Parabolic antennas are commonly used to facilitate radio communications, television communications, data communications, and other applications such as radar. In these applications, parabolic antennas are used either for transmitting and/or receiving signals. To transmit or receive signals to and from a specific remote location, a parabolic antenna may need to be at least generally pointed toward the location. This direction may be represented by an azimuth direction and an elevation angle. Systems and methods to adjust both azimuth direction and elevation angle are therefore necessary to allow a parabolic antenna to transmit and/or receive signals from different remote locations.

Parabolic antennas currently exist in various sizes, from diameters as small as fractions of a meter to as large as tens of meters. Regardless of size, systems for rotating the parabolic antennas will still usually be required to change the direction of the parabolic antenna so the antennas may be used to exchange or derive signals from different locations. These rotation systems must be capable of rotating the mass of the antenna precisely and consistently with as little periodic maintenance as possible. The larger the parabolic antenna, the more torque may need to be delivered by the system to move the parabolic antenna. Furthermore, precise directional alignment of the parabolic antenna may be necessary, especially in applications where weak signals are being received, or when the target of the parabolic antenna is small and/or a great distance away.

### BRIEF DESCRIPTION OF THE DRAWINGS

The present invention is described in conjunction with the appended figures:

FIG. 1A is a front axonometric view of a system which includes a parabolic antenna and subsystems which allow for adjustment of the azimuth direction and elevation angle of the parabolic antenna;

FIG. 1B is a rear axonometric view of the system shown in FIG. 1A showingh the azimuth direction adjustment assembly and elevation angle adjustment assembly;

FIG. 2A is an enlarged view of the portion of the system from FIG. 1B which includes the azimuth direction adjustment assembly;

FIG. 2B is an enlarged view of the azimuth direction adjustment assembly;

FIG. 3A is an enlarged view of the portion of the system from FIG. 1B which includes the elevation angle adjustment assembly;

FIG. 3B is an enlarged view of the elevation angle adjustment assembly;

FIG. 4 is a partially-cut-away axonometric view of an example azimuth direction adjustment assembly or elevation angle adjustment assembly;

FIG. 5 is a flow diagram of the mechanical process by which azimuth direction or elevation angle adjustment may occur in some embodiments of the invention;

FIG. 6 is a mechanical block diagram of one system of the invention for changing the azimuth direction and elevation angle adjustment of a parabolic antenna; and

FIG. 7 is a block diagram of an exemplary computer system capable of being used in at least some portions of the systems of the present invention, or implementing at least some portion of the methods of the present invention.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter suffix.

### DETAILED DESCRIPTION OF THE INVENTION

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a system for changing the azimuth direction of a parabolic antenna is described. The system may include a support member, a first gear set and a first rotational motion source. The support member may be coupled with a surface, the first gear set may be operably coupled with the support member, and the parabolic antenna may be operably coupled with the first gear set. Any of the aforementioned components may be coupled with each other via other unspecified components, including mechanical structural components and/or other movement enabling mechanisms.

The first rotational motion source may be operably coupled with a first worm in the first gear set to provide rotational motion to the system. The first rotational motion source may be operably coupled with the first worm using mechanical couplings, extension shafts, and/or other components. The rotational motion source may be an electric motor, a pneumatic motor, a hydraulic motor, or even a combustion engine in some applications.

The first gear set may include a worm gear and a worm. The first worm may engage the worm gear which may have a substantially vertical axis. In some embodiments, the worm gear may be a slewing ring or a ring gear. Combined, the first worm and the worm gear may be self-locking such that rotation of the worm may rotate the worm gear, but rotation of the worm gear may not rotate the worm. The first gear set may also include a housing which encloses at least a portion of the worm gear and the first worm. The housing may be stationary relative to an axis of rotation of the first worm, but rotate about the substantially vertical axis relative to the worm gear. Therefore, if a first object is coupled with the housing, and a second object is coupled with the worm gear, the first object will rotate relative to the second object, and vice-versa, when the worm rotates. Note that in some embodiments, other mechanical components may be present to allow an object to be coupled with the worm gear.

In some embodiments, the housing may have one or more seals configured to at least nominally seal an interface between moving parts of the first gear set. For example, one side of the gear set may have an opening in the housing which provides a coupling point for the worm gear. This coupling point may rotate relative to the housing, and seals may be provided between the housing and the rotating point to at least nominally seal the interface. Lubricants such as grease and oil may be disposed within the housing to reduce the wear at the engagement point between the worm and worm gear. The interface where the seal or seals reside may be on the underside of the housing as it coupled within the system such that fluids from precipitation, condensation or other sources do not remain stagnant over the seal and infiltrate the housing, reducing the effectiveness of the lubricants therein. Though lubricants may exit the seal in such configurations, the higher viscosity of the lubricants will reduce the rate at which such leaking will occur. Furthermore, adding lubricant to gear set housings is a more typical maintenance operation than tearing down a gear set to remove foreign contaminants.

In one embodiment, the support member may be operably coupled with the worm gear, while the antenna may be operably coupled with the housing. The first rotational motion source may be coupled with the first worm, and when active, cause the parabolic antenna to rotate about the substantially vertical axis. In this embodiment, the worm gear may remain substantially stationary, while causing the first worm to revolve around the worm gear as the worm rotates about its own axis. In this embodiment then, the worm, housing and the first rotational motion source revolve around the substantially vertical axis with the parabolic antenna.

While in some embodiments, the support member may fixedly coupled with the surface, in other embodiments, some freedom of movement may be present in the coupling between the support member and the surface. For example, at least some portion of the support member may be configured to be selectively rotated around an axis perpendicular to the surface, possibly the substantially vertical axis of the worm gear, thereby adjusting a reference “starting” azimuth direction of the antenna. The systems of the invention may thereafter be used to adjust the azimuth direction of the antenna from this “starting” direction. In one example, a support member with such a rotatable coupling may be initially configured to point the antenna in a southwest direction, while using the systems of the invention for adjusting the position of the antenna from that “starting” southwest direction. If operational changes occur, a new “starting” direction, for example northeast, may be set, allowing the system of the invention to changing the azimuth direction of the antenna relative to the new starting direction.

The just described operation may be useful for restricting wear on the worm gear resultant from interacting with the first worm in one particular arc of the worm gear's circumference. In many embodiments, the worm gear may be constructed from softer material than associated worms, thereby causing the worm gear to wear at a faster rate relative to the associated worms. In the example just described above, wear could be restricted to the same general arc of the worm gear through use of the rotatable coupling. If the support member was fixedly coupled with the surface, then wear would occur in two arcs on the worm gears circumference: a first arc representing movement around the “starting” southwest direction, and a second arc representing movement around the “starting” northeast direction.

However, sometimes it may be advantageous to shift the arc of wear to an unused, or less used, arc of the worm gear's circumference, possibly after wear of the worm gear in the current arc has increased backlash between the worm gear and the first worm. This backlash may result in wind and/or other forces on the parabolic antenna forcing small, but undesirable, movements of the parabolic antenna. One possible method of the invention for changing the mesh arc of the worm and worm gear may involve disassembling the first gear set and reorienting the worm gear such that a less used arc engages the worm, and then reassembling the first gear set. However, in the embodiments described above where the support member is rotatably coupled with the surface, the support member may be rotated, and then the worm activated until the parabolic antenna is back in its mean position, thereby engaging the worm gear on a less used arc of the worm gear. These embodiments lessen the amount of effort required to use a new portion of the worm gear because the first gear set does not have to be disassembled.

In another embodiment, the parabolic antenna may be operably coupled with the worm gear, and the support member may be operably coupled with the housing (as opposed to the support member-to-worm-gear and parabolic antenna-to-housing embodiment described above). The first rotational motion source may be coupled with the first worm, and when active, cause the parabolic antenna to rotate about the substantially vertical axis. In this embodiment, the rotational axis of the worm may remain substantially stationary, causing the worm gear to rotate about the substantially vertical axis as the worm rotates about its own axis. In this embodiment then, the housing and the first rotational motion source remain stationary as the parabolic antenna rotates.

In some embodiments, the system for changing the azimuth direction may also include a second gear set. In these embodiments, the first rotational motion source may be operably coupled with the second gear set, and the second gear set may be operably coupled with the first worm. Thus, the second gear set may be used to change the speed of the rotational motion received from the first rotational motion source before it is transferred to the first worm, depending on the gear ratio of the second gear set. The second gear set may therefore be used to increase torque at the expense of rotational speed, or increase rotational speed at the expense of torque.

In some embodiments, the first gear set may also include a second worm which engages the worm gear. These embodiments may also include a second rotational motion source, where the second rotational motion source is operably coupled with the second worm. In this fashion, the combined work from both rotational motion sources may be combined to rotate the antenna. Increasingly more worms and rotational sources could be added to the first gear set depending on the size of the worms relative to the worm gear and other space constraints. While wear on the worm gear may occur at multiple arcs on the worm gear in these embodiments, the wear in any one arc will be less because the mechanical work required to rotate the parabolic antenna will occur over a greater number of arcs on the worm gear.

In some embodiments the system for changing the azimuth direction of a parabolic antenna may also include a sensing mechanism and a control system. The sensing mechanism may be configured to determine an approximate azimuth direction of the antenna, while the control system may be configured to selectively activate and deactivate the first rotational motion source in either rotational direction until the approximate azimuth direction is substantially equivalent to desired azimuth direction.

The sensing mechanism may, for example, include a vernier and an optical sensor which observes the vernier and transmits data to the control system capable of interpreting the data. The control system may determine either: an absolute angular position of the parabolic antenna, possibly by first determining an angular position of the parabolic antenna relative to the support member; or a relative angular position of the parabolic antenna relative to a previous angular position. Other types of sensing mechanisms could also be employed, including electromagnetic sensors and mechanical position sensors.

In another embodiment of the invention, methods for changing the azimuth direction of a parabolic antenna are described. The methods may or may not employ at least some portions of the systems described above. In one embodiment, the method may include providing a first gear set operably coupled with a support member and the parabolic antenna; providing a first rotational motion source, where the first rotational motion source may be operably coupled with a first worm within the first gear set; activating the first rotational motion source to generate a first rotational motion; and receiving the first rotational motion with the first worm to rotate the parabolic antenna about the substantially vertical axis. In some embodiments, the method may also include determining an approximate azimuth direction of the parabolic antenna, and activating the first rotational motion source until the approximate azimuth direction is substantial equivalent to a desired azimuth direction.

In some embodiments, the method may include providing a second gear set, and changing the speed of the first rotational motion received by the first worm with the second gear set. In these or other embodiments, the method may also include providing the various types of gear sets described above which employ more than one worm and a second rotational motion source.

Some methods of the invention may include using multiple worms to at least attempt to rotate parabolic antenna in opposite directions for a period of time in embodiments where there is backlash between the worms and the worm gear. By attempting to rotate the worm gear in opposite directions, the worm gear will become substantially locked in relation to the two worms. This will prevent the worm gear from rotating in the direction of available backlash, either between the first worm and worm gear, or between the second worm and the worm gear.

In another embodiment of the invention, machine-readable mediums having machine executable instructions for changing the azimuth direction of a parabolic antenna are described. The machine-readable medium may include machine-executable instructions for activating a first rotational motion source in any of the systems described above to rotate a parabolic antenna, and then deactivating the first rotational motion source to achieve an adjusted azimuth direction of the parabolic antenna. In some embodiments the machine-readable medium may include machine-executable instructions for activating a second rotational motion source, where one is available, such as in some of the systems described above.

In some embodiments, the machine-readable medium may include machine-executable instructions for activating the first rotational motion source to at least attempt to rotate the parabolic antenna in a first rotational direction, and also activating the second rotational motion source to at least attempt to rotate the parabolic antenna in a second rotational direction, where the second rotational direction is opposite the first rotational direction. These machine-readable mediums may also include machine-executable instructions for deactivating the first rotation motion source and the second rotational motion source when the worm gear is substantially locked in relation to the first worm and the second worm for at least the same purposes as described above.

In some embodiments, the machine-readable medium may include machine-executable instructions for receiving a signal from a sensing mechanism, determining an approximate azimuth direction of the parabolic antenna based at least in part on the signal, and activating the first rotational motion source in either rotational direction until the approximate azimuth direction is substantial equivalent to a desired azimuth direction.

In another embodiment of the invention, systems for changing the elevation angle of a parabolic antenna are described. In one embodiment, the system may include a support member, a first gear set, and a first rotational motion source. The first gear set may include a worm gear and first worm. In some embodiments, the worm gear may be a slewing ring or a ring gear. The first worm may engage the worm gear and the worm gear may have a substantially horizontal axis. Combined, the first worm and the worm gear may be self-locking such that rotation of the worm may rotate the worm gear, but rotation of the worm gear may not rotate the worm. The first gear set may also include a housing which encloses at least a portion of the worm gear and the first worm. The housing may be stationary relative to an axis of rotation of the first worm, but rotate about the substantially horizontal axis relative to the worm gear.

In one embodiment, the support member may be operably coupled with the first gear set, and the and the parabolic antenna may be operably coupled with the first gear set. Any of the aforementioned components may be coupled with each other via other unspecified components, including mechanical structural components and/or other movement enabling mechanisms. For example, the support member may be coupled with a pivot member, and the pivot member may be coupled with another gear set for adjusting the azimuth direction of the parabolic antenna, and that gear set may be coupled with the support member. Likewise, while the parabolic antenna may be coupled with the pivot member at one point via the first gear set, a bearing, or other rotational coupling, may also couple with parabolic antenna with the pivot member at another point. The bearing may allow the parabolic antenna to rotate relative to the pivot member depending on the movement produced by the first gear set and first rotational motion source.

The first rotational motion source may be operable coupled with the first worm and the parabolic antenna may rotate about the substantially horizontal axis when the first rotational motion source is active. The first rotational motion source may be operably coupled with the first worm using mechanical couplings, extension shafts, and/or other components. The rotational motion source may be an electric motor, a pneumatic motor, a hydraulic motor, or even a combustion engine in some applications.

In some embodiments, the parabolic antenna may be coupled with the worm gear, and the housing may be coupled with the support member and/or pivot member. In these embodiments, the worm gear may be configured to rotate about the substantially horizontal axis when the first worm transfers rotational motion with the worm gear. In other embodiments, the support member and/or pivot member may be coupled with the worm gear, while the parabolic antenna may be coupled with the housing. In these embodiments, the first worm may have a rotational axis and the first worm may revolve around the substantially horizontal axis when the first worm rotates about its rotational axis.

In some embodiments, the system for changing the elevation angle may also include a second gear set. In these embodiments, the second gear set may be operably coupled with the first rotational motion source and the first worm. Thus, the second gear set may be used to change the speed of the rotational motion received from the first rotational motion source before it is transferred to the first worm, depending on the gear ratio of the second gear set. The second gear set may therefore be used to increase torque at the expense of rotational speed, or increase rotational speed at the expense of torque.

In some embodiments, the first gear set may also include a second worm which engages the worm gear. These embodiments may also include a second rotational motion source, where the second rotational motion source is operably coupled with the second worm. In this fashion, the combined work from both rotational motion sources may be combined to rotate the antenna. Increasingly more worms and rotational sources could be added to the first gear set depending on the size of the worms relative to the worm gear and other space constraints. While wear on the worm gear may occur at multiple arcs on the worm gear in these embodiments, the wear in any one arc will be less because the mechanical work required to rotate the parabolic antenna will occur over a greater number of arcs on the worm gear.

As discussed above in regard to the gear set used to adjust azimuth direction of the parabolic antenna, a rotatable coupling may be used in the elevation angle adjustment gear set to couple either the pivot member and/or support member with the first gear set, or the parabolic antenna with the first gear set. This may allow a new arc on the worm gear to be engaged by the worm or worms in the first gear set without disassembling the gear set and rotating the worm gear relative to the worm and then reassembling.

In some embodiments, the system for changing the elevation angle of a parabolic antenna may also include a sensing mechanism and a control system. The sensing mechanism may be configured to determine an elevation angle of the antenna, while the control system may be configured to selectively activate and deactivate the first rotational motion source in either rotational direction until the approximate elevation angle is substantially equivalent to desired elevation angle.

The sensing mechanism may, for example, include a vernier and an optical sensor which observes the vernier and transmits data to the control system capable of interpreting the data. The control system may determine either: an absolute angular position of the parabolic antenna, possibly by first determining an angular position of the parabolic antenna relative to the support member; or a relative angular position of the parabolic antenna relative to a previous angular position. Other types of sensing mechanisms could also be employed, including electromagnetic sensors and mechanical position sensors.

In another embodiment of the invention, methods for changing the elevation angle of a parabolic antenna are described. The method may include providing a first gear set operably coupled with a support member and the parabolic antenna. The first gear set may include a worm gear and a first worm, where the first worm may engage the worm gear, the worm gear may have a substantially horizontal axis, and the support member and the parabolic antenna may be operably coupled with the first gear set. The method may further include providing a first rotational motion source, where the first rotational motion source may be operably coupled with the first worm, and activating the first rotational motion source to generate a first rotational motion. Furthermore, the method may include receiving the first rotational motion with the first worm to rotate the parabolic antenna about the substantially horizontal axis.

In some embodiments, the parabolic antenna being operably coupled with the first gear set may include the parabolic antenna coupled with the worm gear, where the worm gear may be configured to rotate about the substantially horizontal axis, and the first worm may be configured to transfer rotational motion with the worm gear. In other embodiments, the support member being operably coupled with the first gear set may include the support member coupled with the worm gear, where the first worm may have a rotational axis, and the first worm may be configured to revolve around the substantially horizontal axis when the first worm rotates about the rotational axis.

In some embodiments, the methods for changing the elevation angle of a parabolic antenna may include providing a second gear set, and changing the speed of the first rotational motion received by the first worm with the second gear set. In these or other embodiments, the first gear set may further include a second worm which engages the worm gear, and the method may include providing a second rotational motion source, where the second rotational motion source is operably coupled with the second worm. The method may further include activating the second rotational motion source to generate a second rotational motion, and receiving the second rotational motion with the second worm to rotate the parabolic antenna about the substantially horizontal axis.

Some methods of the invention may include using multiple worms to at least attempt to rotate parabolic antenna in opposite directions for a period of time in embodiments where there is backlash between the worms and the worm gear. By attempting to rotate the worm gear in opposite directions, the worm gear will become substantially locked in relation to the two worms. This will prevent the worm gear from rotating in the direction of available backlash, either between the first worm and worm gear, or between the second worm and the worm gear.

In some embodiments, the methods for changing the elevation angle of a parabolic antenna may include determining an approximate elevation angle of the parabolic antenna, and activating the first rotational motion source until the approximate elevation angle is substantial equivalent to a desired elevation angle.

In another embodiment of the invention, machine-readable mediums having machine executable instructions for changing the elevation angle of a parabolic antenna are described. The machine-readable medium may include machine-executable instructions for activating a first rotational motion source to generate a first rotational motion. The first rotational motion source may be operably coupled with a first gear set which includes a first worm engaging a worm gear. The first gear set may be operably coupled with a parabolic antenna, and the parabolic antenna may rotate about a substantially horizontal axis when the first rotational motion source is active. The machine-readable medium may also include machine-executable instructions for deactivating the first rotational motion source.

In some embodiments, the first gear set being operably coupled with the parabolic antenna may include the parabolic antenna coupled with the worm gear. In other embodiments, the first gear set being operably coupled with the parabolic antenna may include a support member coupled with the worm gear.

In some embodiments, the machine-readable medium may further include machine-executable instructions for activating a second rotational motion source to generate a second rotational motion. The first gear set may further include a second worm engaging the worm gear, and the second rotational motion source may be operably coupled with the second worm. There may also be machine-executable instructions for deactivating the second rotational motion source.

In some embodiments, the machine-readable medium may also include machine-executable instructions for activating the first rotational motion source to at least attempt to rotate the parabolic antenna in a first rotational direction and activating the second rotational motion source to at least attempt to rotate the parabolic antenna in a second rotational direction, where the second rotational direction is opposite the first rotational direction. Furthermore, these embodiments may also include machine-executable instructions for deactivating the first rotation motion source and the second rotational motion source when the worm gear may be substantially locked in relation to the first worm and the second worm.

In some embodiments, machine-readable mediums having machine executable instructions for changing the elevation angle of a parabolic antenna may also include machine-readable instructions for receiving a signal from a sensing mechanism, and determining an approximate elevation angle of the parabolic antenna based at least in part on the signal. Furthermore, these embodiments may include machine-executable instructions for activating the first rotational motion source in either rotational direction until the approximate elevation angle is substantial equivalent to a desired elevation angle.

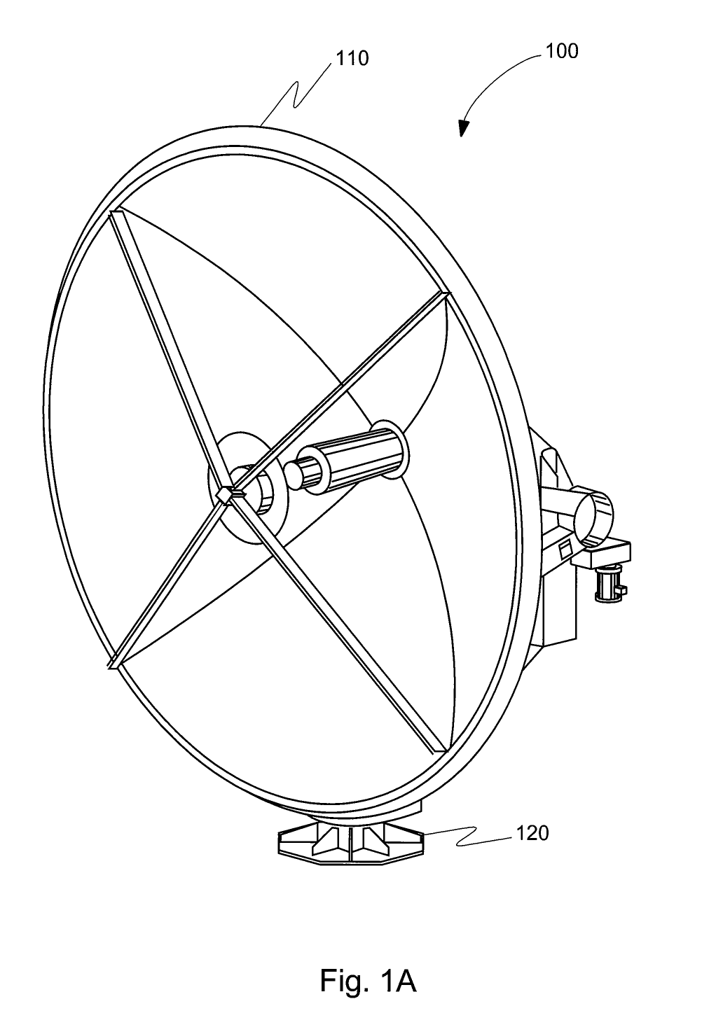

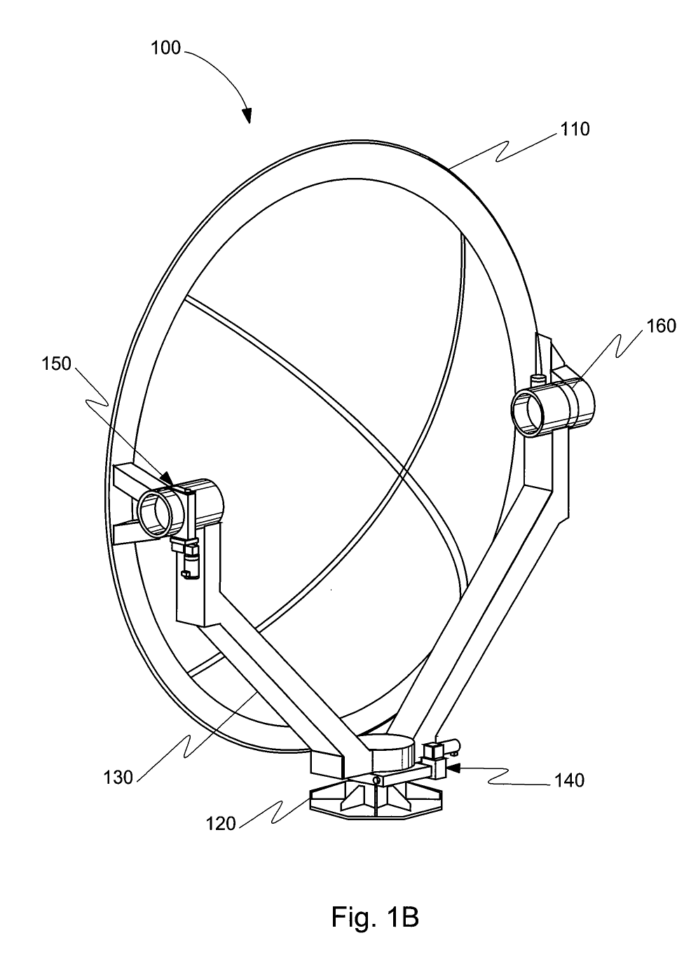

Turning now to FIG. 1A and FIG. 1B, one possible system 100 of the invention is shown. System 100 includes a parabolic antenna 110, a support member 120, a pivot member 130, an azimuth direction adjustment assembly (“ADA assembly”) 140, an elevation angle adjustment assembly (“EAA assembly”) 150, and a bearing 160. In this embodiment, support member 120 is fixedly coupled with a surface (not shown). Support member 120 is operably coupled with ADA assembly 140. ADA assembly 140 is also operably coupled with pivot member 130, which in turn is operably coupled with EAA assembly 150. EAA assembly 150 is the operably coupled with parabolic antenna 110.

When the azimuth direction of parabolic antenna 110 needs to be adjusted, ADA assembly 140 may be activated and pivot member 130 will rotate relative to support member 120. Because pivot member is coupled with parabolic antenna 110 through EAA assembly 150, parabolic antenna 110 will rotate about a vertical axis which may be defined by ADA assembly 140.

When the elevation angle of parabolic antenna 110 needs to be adjusted, EAA assembly 150 may be activated and parabolic antenna 110 will rotate relative to pivot member 130. Because pivot member is coupled to a surface through ADA assembly 140 and support member 120, parabolic antenna 110 will rotate about an axis which is horizontal relative to the surface. The horizontal axis may be defined by EAA assembly 150, and may itself rotate as ADA assembly rotates pivot member 130.

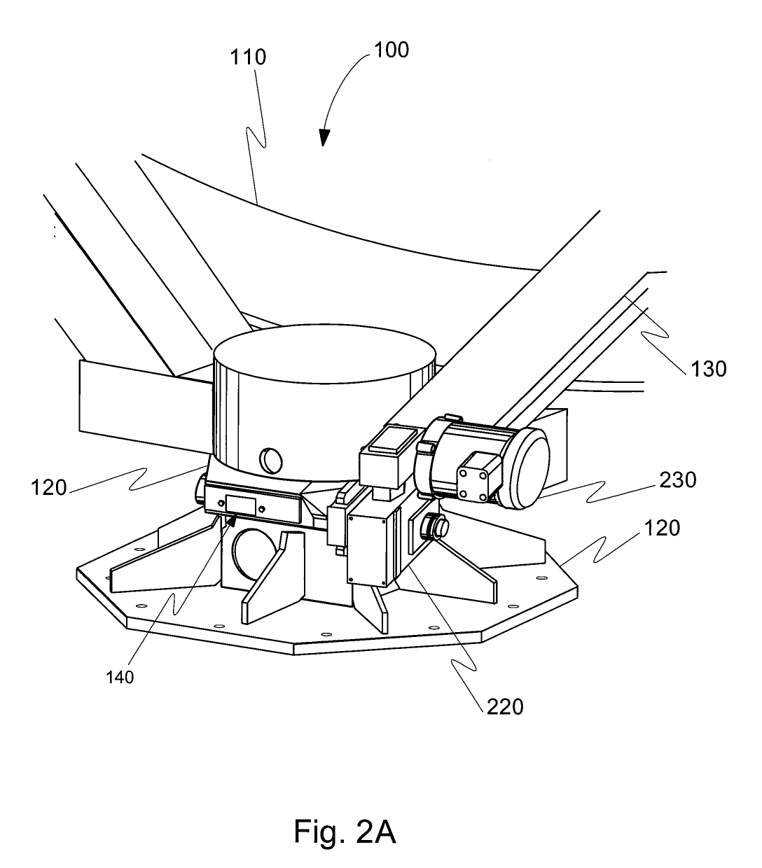

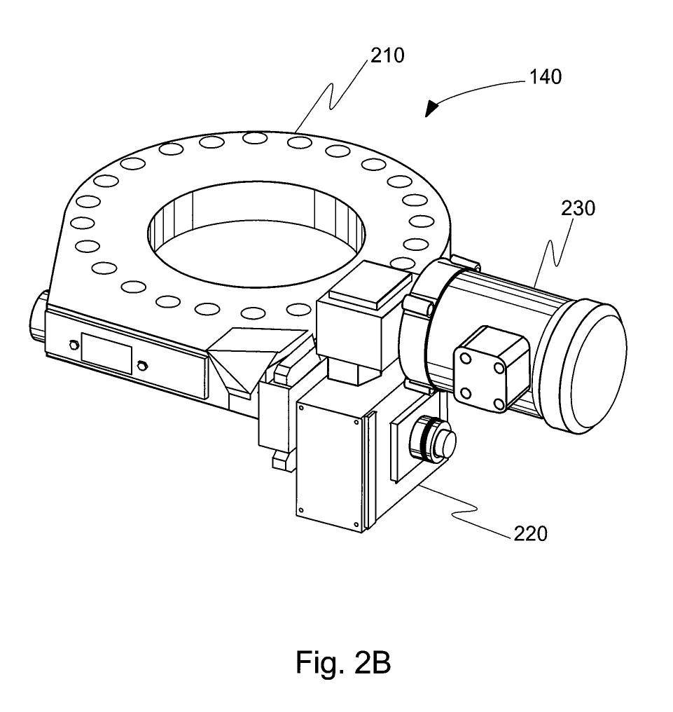

FIG. 2A shows a closer view of ADA assembly 140 and surrounding components. FIG. 2B shows a closer view of ADA assembly 140 and its sub-components. ADA assembly 140 may include a first gear set 210 which includes a housing, a worm gear, and a worm; a second gear set 220; and a rotational motion source 230 (shown here as a motor). When rotational motion source 230 is activated, it will transfer rotational motion to second gear set 220. Second gear set 220 may change the speed of the rotational motion and transfer the modified rotational motion to the worm in first gear set 210.

Support member 120 is coupled with the worm gear on the underside of first gear set 210. Pivot member 130 is coupled with the housing of first gear set 210 on the topside of first gear set 210. The worm in first gear set 210 has a rotational axis which is substantially stationary relative to the housing of first gear set 210. As the worm rotates when receiving the modified rotational motion from second gear set 220, the worm revolves around the worm gear, and therefore the housing of the first gear set 210 rotates about the vertical axis of the worm gear. Because pivot member 130 is coupled to both parabolic antenna 110 and the housing of first gear set 210, parabolic antenna rotates as the worm revolves around the worm gear, thereby changing the azimuth direction of the parabolic antenna. In this embodiment then, second gear set 220 and rotational motion source 230 rotate with pivot member 130 and parabolic antenna 110. This may be advantageous because second gear set 220 and rotational motion source 230 may use the same clearance space set aside for the rotation of parabolic antenna 110.

Seals may exist on first gear set 210 to close interfaces between the worm gear and the housing. This assists in keeping undesirable liquids and solids, such as water and particulates, from entering the interfaces and causing accelerated wear between the teeth of the worm gear and the worm. Additionally, the seals assist in retaining lubricants, such as gear grease, within the housing, which reduces wear between the teeth of the worm gear and the worm. By orientating first gear set 210 in a manner which places the seals on the underside of first gear set 210, moisture, possibly from sources such as precipitation, will not collect on the seal face, therefore at least reducing the amount of undesirable ingress into the housing.

In another possible embodiment of the invention, ADA assembly 140 may be inverted compared to its position in FIG. 2A and FIG. 2B. In this embodiment, pivot member 130 may be coupled with the worm gear of first gear set 210, and support member 120 may be coupled with the housing of first gear set 210. In such an embodiment, the rotational axis of the worm remains stationary and therefore the housing of first gear set 210 also remains stationary. Instead, the worm gear of first gear set 210 rotates about its vertical axis as it receives rotational motion from the worm, therefore rotating pivot member 130 and parabolic antenna 110 which is coupled with pivot member 130. In this embodiment then, second gear set 220 and rotational motion source 230 are stationary with respect to pivot member 130 and parabolic antenna 110.

ADA assembly 140, or other portions of system 100, may include a sensing mechanism which determines an angular position of pivot member 130, and hence parabolic antenna 110, relative to support member 120 or the surface to which support member 120 is coupled. The sensing mechanism may, for example, include a vernier and an optical sensor which observes the vernier and transmits data to a control system capable of interpreting the data. The control system may determine either: an absolute angular position of parabolic antenna 110, possibly by first determining an angular position of parabolic antenna 110 relative to support member 120; or a relative angular position of parabolic antenna 110 relative to a previous position.

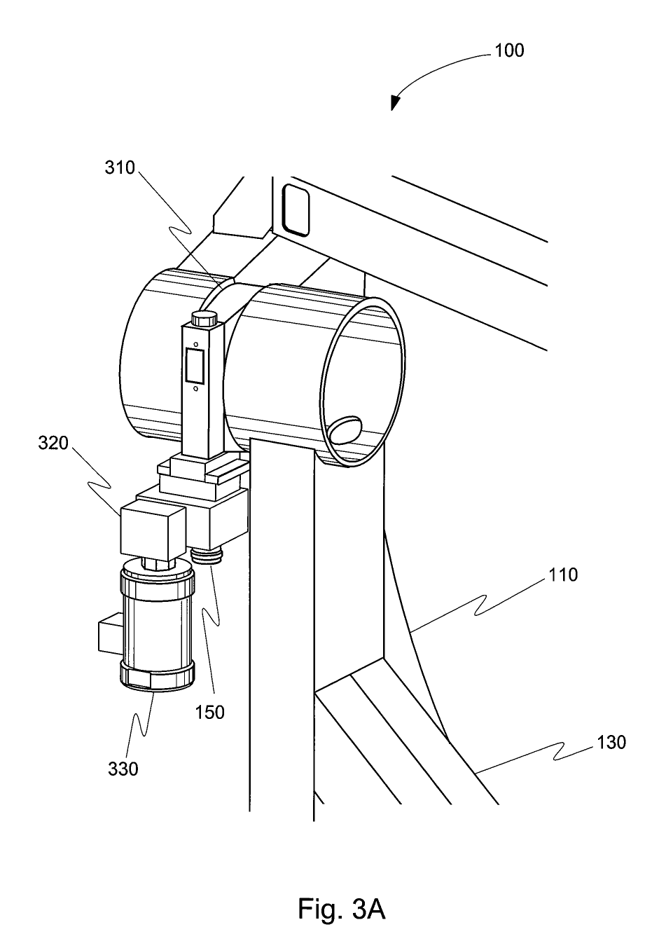

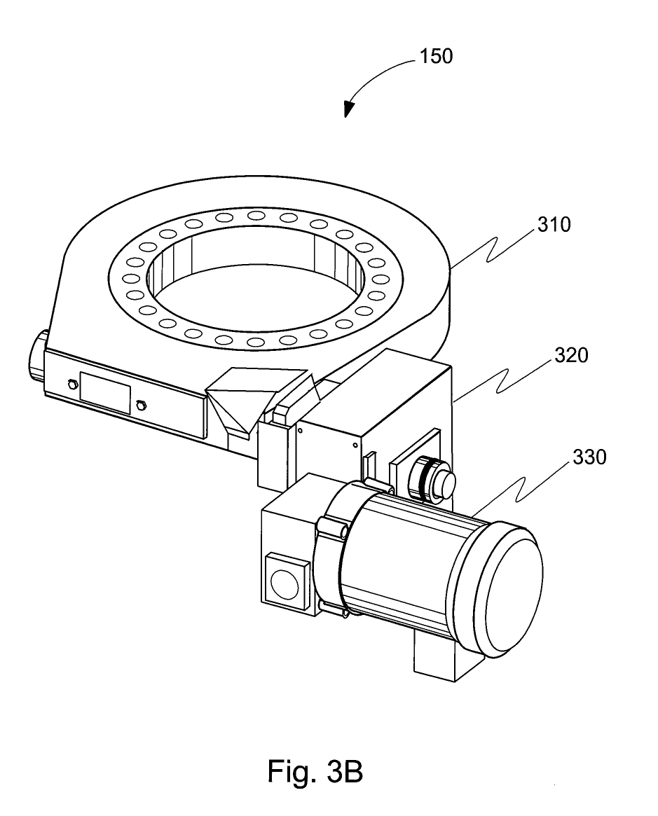

FIG. 3A shows a closer view of EAA assembly 150 and surrounding components. FIG. 3B shows a closer view of EAA assembly 150 and its sub-components. EAA assembly 150 may include a first gear set 310 which includes a housing, a worm gear, and a worm; a second gear set 320; and a rotational motion source 330 (shown here as a motor ). When rotational motion source 330 is activated, it will transfer rotational motion to second gear set 320. Second gear set 320 may change the speed of the rotational motion and transfer the modified rotational motion to the worm in first gear set 310.

Parabolic antenna 110 is coupled with the worm gear on the left side of first gear set 310. Pivot member 130 is coupled with the housing of first gear set 310 on the right side of first gear set 310. As the worm rotates when receiving the modified rotational motion from second gear set 320, the worm transfers rotational motion with the worm gear, and therefore the worm gear rotates about the horizontal axis of the worm gear. Because parabolic antenna 110 is coupled with the worm gear of first gear set 310, parabolic antenna rotates as the worm gear rotates, thereby changing the elevation angle of the parabolic antenna. In this embodiment then, second gear set 320 and rotational motion source 330 are stationary as parabolic antenna 110 rotates.

In another possible embodiment of the invention, EAA assembly 150 may be inverted compared to its position in FIG. 3A and FIG. 3B. In this embodiment, pivot member 130 may be coupled with the worm gear of first gear set 310, and parabolic antenna 110 may be coupled with the housing of first gear set 310. In such an embodiment, the worm gear remains stationary. Instead, the worm of first gear set 310 revolves around the horizontal axis as it rotates. Because the housing of first gear set 310 is stationary relative to the rotational axis of the worm, and parabolic antenna 110 is coupled with the housing, parabolic antenna 110 will rotate as the worm revolves around the substantially horizontal axis of the worm gear. In this embodiment then, second gear set 320 and rotational motion source 330 rotate with parabolic antenna 110.

EAA assembly 150, or other portions of system 100, may include a sensing mechanism which determines an angular position of parabolic antenna 110 relative to pivot member 130 or some other reference vector. The sensing mechanism may, for example, include a vernier and an optical sensor which observes the vernier and transmits data to a control system capable of interpreting the data. The control system may determine either an absolute angular position of parabolic antenna 110, possibly by first determining an angular position of parabolic antenna 110 relative to support member 120.

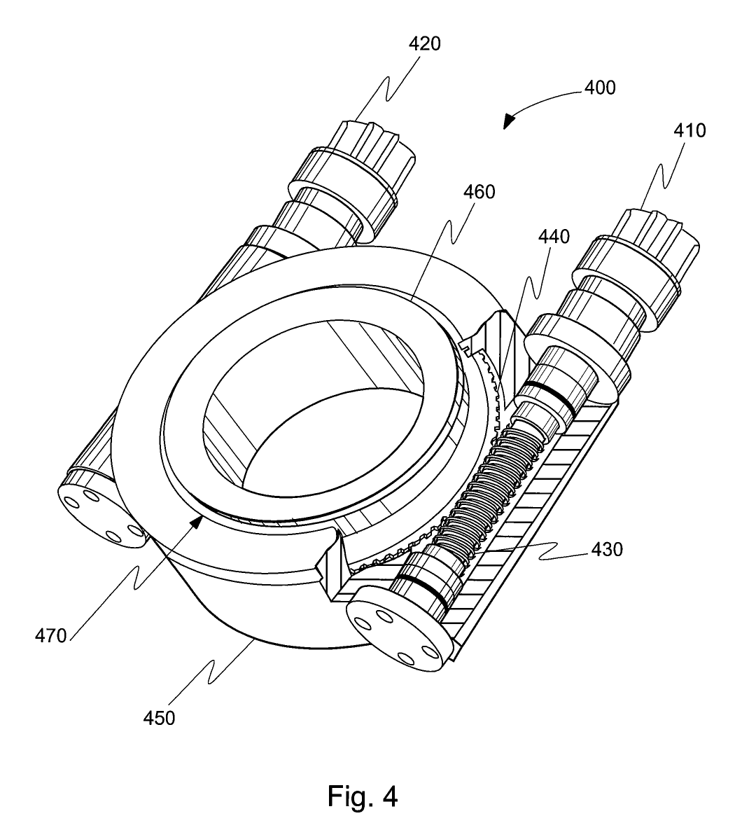

FIG. 4 shows partially-cut-away axonometric view of an example ADA assembly or EAA assembly 400. In this example, assembly 400 includes a first rotational motion source 410 (shown here as a motor), a second rotational motion source 420 (shown here as a motor), a first worm 430, a second worm (hidden from view), a worm gear 440, a housing 450, a worm gear coupling member 460, and a seal 470. In this example, both rotational motion sources 410, 420 may be activated and hence turn first worm 430 and second worm. First worm 430 and second worm may then rotate worm gear 440. Worm gear coupling member 460 may be fixedly coupled with worm gear 440, thereby causing worm gear coupling member 460 to rotate whenever first rotational motion source 410 and second rotational motion source 420 are activated in concert. Housing 450 may also have coupling points on its underside allowing coupling to other elements in a similar fashion to worm gear coupling member. Note that assembly 400 differs from assemblies 140, 150 previously discussed because there are no secondary gear sets (such as second gear sets 220, 230) to adjust the speed of the rotational motion provided by first rotational motion source 410 and second rotational motion source 420.

As described above, such an assembly 400 can function in at least two differing manners. Considering for example using assembly 400 as the ADA assembly. In a first configuration, housing 450 may be coupled with pivot member 130 and consequently parabolic antenna 110, while worm gear coupling member 460 may be coupled with support member 120. In such a configuration, housing 450, first worm 430, second worm, first rotational motion source 410, and second rotational motion source 420 will rotate with the parabolic antenna. In a second configuration, worm gear coupling member 460 may be coupled with pivot member 130 and consequently parabolic antenna 110, while housing 450 may be coupled with support member 120. In such a configuration, housing 450, the axis of first worm 430, the axis of second worm, first rotational motion source 410, and second rotational motion source 420 will remain stationary when the parabolic antenna rotates.

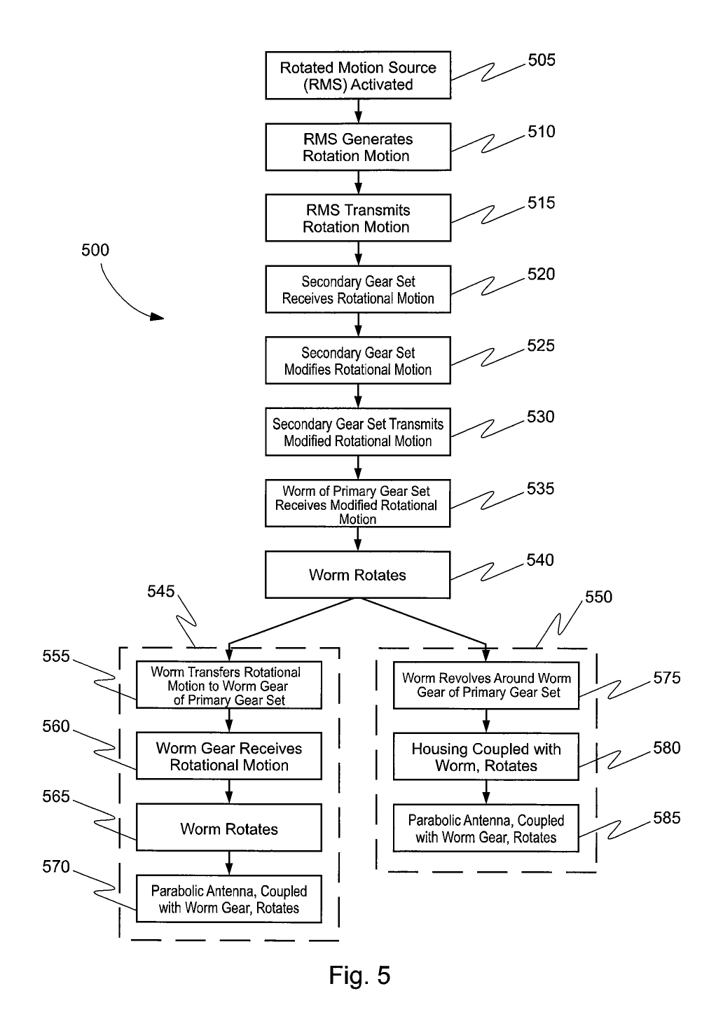

FIG. 5 is a flow diagram of the mechanical process by which azimuth direction or elevation angle adjustment may occur in some embodiments of the invention. At block 505, a rotational motion source may be activated. This may occur because a new target for transmissions from the parabolic antenna has been selected, or reception from a different source is required. Other reasons for activation of the rotational motion source may include correction and/or adjustment related to movement of either the parabolic antenna or the target/source.

At block 510, the rotational motion source generates rotational motion. At block 515, this motion is transmitted, possibly via shafts, clutches, couplings, and/or other mechanical elements, to another component. In some embodiments, at block 520, the motion will be received by a secondary gear set. The secondary gear set may adjust the speed of the rotational motion received, either reducing or increasing the speed, while increasing or reducing the torque. Various gear sets known in the art may fulfill this purpose. Higher speeds may be required where faster tracking is required by the parabolic antenna, while higher torques may be required for larger parabolic antenna systems.

At block 530, the secondary gear set transmits the modified rotational motion, possibly via shafts, clutches, coupling, and/or other mechanical elements to another component. At block 535, the worm of a primary gear set receives the modified rotational motion, causing the worm to rotate at block 540.

Depending on the configuration, as described above, one of two sequences of events will occur at this point. If the parabolic antenna is coupled with the worm gear, then the first sequence 545 will proceed. If the parabolic antenna is coupled with the housing, then the second sequence 550 will proceed.

Proceeding using the first sequence 545, where the parabolic antenna is coupled with the worm gear of the primary gear set, at block 555 the worm will transfer its rotational motion to the worm gear of the primary gear set. At block 560, the worm gear receives the rotational motion, causing the worm gear to rotate at block 565. At block 570, the parabolic antenna will rotate because it is coupled with the worm gear.

Proceeding using the second sequence 550, where the parabolic antenna is coupled with the housing of the primary gear set, at block 575 the worm's rotational motion will cause it to revolve around the worm gear of the primary gear set. At block 580, the housing will rotate because it is coupled with the axis of worm, possibly via bearings supporting the shaft of the worm. At block 585, the parabolic antenna will rotate because it is coupled with the housing.

Note that the two sequences shown in FIG. 5 may be employed for either azimuth direction adjustment or elevation angle adjustment. The primary difference being that for azimuth direction adjustment, the axis of the worm gear is substantially vertical, while for elevation angle adjustment, the axis or the worm gear is substantially horizontal.

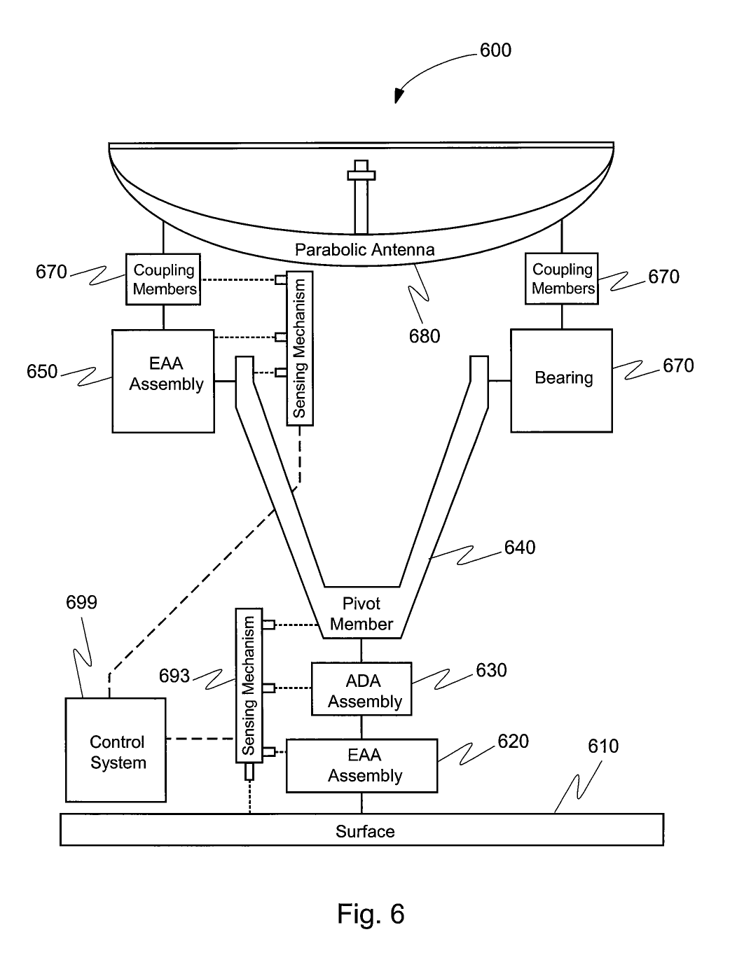

FIG. 6 shows a mechanical block diagram of one system of the invention for changing the azimuth direction and elevation angle adjustment of a parabolic antenna. Shown in FIG. 6 is a surface 610 to which support member 620 is coupled. As discussed above, support member 620 may be either fixedly or rotatably coupled with surface 610.

Support member 620 is, in turn, operably coupled with ADA assembly 630 which is also operably coupled with pivot member 640. As discussed above, ADA assembly 630 may be various different possible arrangements, possibly dependent on how it is coupled with support member 620 and or pivot member 640.

Pivot member 640 is operably coupled with both an EAA assembly 650 and a bearing 660. A parabolic antenna 680 is operably coupled to both EAA assembly 650 and bearing 660, possibly through coupling members 670. Coupling members may include structural or fastening elements which allow the parabolic antenna to interface with the available coupling mechanisms/methods on EAA assembly 650 and bearing 660. Note that in some embodiments, possibly those involving larger parabolic antennas 680, a second EAA assembly may replace bearing 660, providing for increased amount of torque to be delivered by the combined efforts of both EAA assemblies.

A sensing mechanism 693 may monitor at least a portion of one or more of surface 610, support member 620, ADA assembly 630, and pivot member 640, and transmits data to control system 699. Control system 699 may interpret the data to determine an angular position of pivot member 640, and hence parabolic antenna 680 relative to a stationary portion of ADA assembly 630, support member 620, or surface 610. This angular position, equivalent to parabolic antenna's 680 azimuth direction, may be compared to a desired azimuth direction and ADA assembly 630 may be activated in either rotational direction until the determined azimuth direction is equal to, or within a certain range of, the desired azimuth direction. In some applications, ADA assembly 630 may be continually active during tracking of a target or source of signals transmitted or received by parabolic antenna 680.

Another sensing mechanism 696 may monitor at least a portion of one or more of pivot member 640, EAA assembly 650, and coupling members 670 (or possibly parabolic antenna 680 itself), and transmits data to control system 699. Control system 699 may interpret the data to determine an angular position of parabolic antenna 680 relative to a standard horizon position. This angular position, equivalent to parabolic antenna's 680 elevation angle, may be compared to a desired elevation angle, and EAA assembly 650 may be activated in either rotational direction until the determined elevation angle is equal to, or within a certain range of, the desired elevation angle. In some applications, EAA assembly 650 may be continually active during tracking of a target or source of signals transmitted or received by parabolic antenna 680.

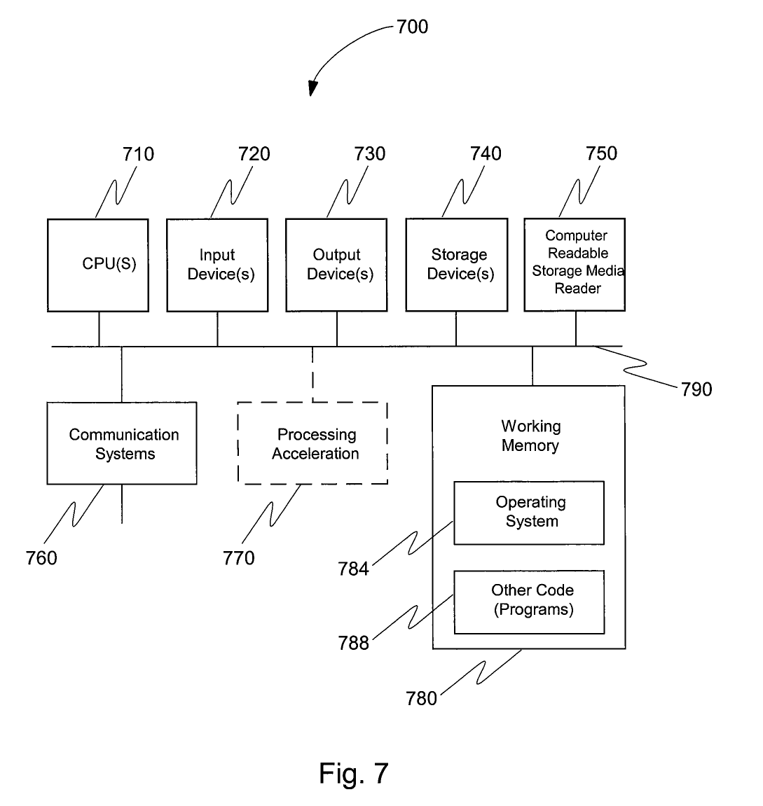

FIG. 7 is a block diagram illustrating an exemplary computer system in which at least portions of the present invention may be implemented. This example illustrates a computer system 700 such as may be used, in whole, in part, or with various modifications, to provide the functions of the sensing mechanisms 693,696, the control system 699 and/or other components of the invention such as those discussed above. For example, various functions of the control system 699 may be controlled by the computer system, for example, accepting and storing a desired azimuth direction or elevation angle, either from a user or an another computer; determining an approximate azimuth direction or elevation angle of a parabolic antenna; activating rotational motion sources to change the approximate azimuth direction or elevation angle of a parabolic antenna; etc.

The computer system 700 is shown comprising hardware elements that may be electrically coupled via a bus 790. The hardware elements may include one or more central processing units (CPUs) 710, one or more input devices 720 (e.g., a mouse, a keyboard, etc.), and one or more output devices 730 (e.g., a display device, a printer, etc.). The computer system 700 may also include one or more storage device 740. By way of example, storage device(s) 740 may be disk drives, optical storage devices, solid-state storage device such as a random access memory (“RAM”) and/or a read-only memory (“ROM”), which can be programmable, flash-updateable and/or the like.

The computer system 700 may additionally include a computer-readable storage media reader 750, a communications system 760 (e.g., a modem, a network card (wireless or wired), an infra-red communication device, etc.), and working memory 780, which may include RAM and ROM devices as described above. In some embodiments, the computer system 700 may also include a processing acceleration unit 770, which can include a DSP, a special-purpose processor and/or the like.

The computer-readable storage media reader 750 can further be connected to a computer-readable storage medium, together (and, optionally, in combination with storage device(s) 740) comprehensively representing remote, local, fixed, and/or removable storage devices plus storage media for temporarily and/or more permanently containing computer-readable information. The communications system 760 may permit data to be exchanged with a network and/or any other computer described above with respect to the system 700.

The computer system 700 may also comprise software elements, shown as being currently located within a working memory 780, including an operating system 784 and/or other code 788. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

Software of computer system 700 may include code 788 for implementing any or all of the function of the various elements of the architecture as described herein. For example, software, stored on and/or executed by a computer system such as system 700, can provide the functions of the sensing mechanisms 693,696, the control system 699 and/or other components of the invention. Methods implementable by software on some of these components has been discussed above in more detail.

A number of variations and modifications of the disclosed embodiments can also be used. For example, an increased number of EAA or ADA assemblies could be used when high speed and/or torque are necessary, or approximate azimuth direction and elevation angle may be determined by knowing an initial position of the parabolic antenna and calculating the present position based on how long, and in what direction the EAA and ADA assemblies have been activated. Also, while some of the embodiments discuss adjusting the azimuth direction and elevation angle of a parabolic antenna, other embodiments could be employed to change the orientation of devices. For example, the systems and methods described above could be used to rotate weapons systems, for example mounted firearms, lasers and/or sonic systems. Other possible uses include sports equipment such as ball throwers. Optical systems could use the systems and methods described above to rotate lenses, mirrors and/or other optic components. Robotic arms could also be manipulated in a similar fashion, perhaps in manufacturing environments where one robotic arm must perform work in a variety of positions.

The invention has now been described in detail for the purposes of clarity and understanding. However, it will be appreciated that certain changes and modifications may be practiced within the scope of the appended claims.

What is claimed is:

1. A system for changing the elevation angle of a parabolic antenna, the system comprising:
a support member;
a first gear set, wherein:
the first gear set comprises a worm gear and a first worm;
the first worm engages the worm gear;
the worm gear has a substantially horizontal axis; and
the support member and the parabolic antenna are operably coupled with the first gear set; and
a first rotational motion source, wherein:
the first rotational motion source is operably coupled with the first worm; and
the parabolic antenna rotates about the substantially horizontal axis when the first rotational motion source is active.

2. The system for changing the elevation angle of a parabolic antenna of claim 1, wherein:
the parabolic antenna being operably coupled with the first gear set comprises the parabolic antenna coupled with the worm gear;
the worm gear is configured to rotate about the substantially horizontal axis; and
the first worm is configured to transfer rotational motion with the worm gear.

3. The system for changing the elevation angle of a parabolic antenna of claim 1, wherein:
the support member being operably coupled with the first gear set comprises the support member coupled with the worm gear;
the first worm comprises a rotational axis; and
the first worm is configured to revolve around the substantially horizontal axis when the first worm rotates about the rotational axis.

4. The system for changing the elevation angle of a parabolic antenna of claim 1, the system further comprising:
a second gear set, wherein the first rotational motion source being operably coupled with the first worm comprises:
the second gear set being operably coupled with the first rotational motion source; and
the second gear set being operably coupled with the first worm.

5. The system for changing the elevation angle of a parabolic antenna of claim 1, wherein the first gear set further comprises a second worm, wherein the second worm engages the worm gear.

6. The system for changing the elevation angle of a parabolic antenna of claim 5, the system further comprising a second rotational motion source, wherein the second rotational motion source is operably coupled with the second worm.

7. The system for changing the elevation angle of a parabolic antenna of claim 1, the system further comprising:
a sensing mechanism configured to determine an approximate elevation angle of the parabolic antenna; and
a control system configured to selectively activate and deactivate the first rotational motion source in either rotational direction until the approximate elevation angle is substantial equivalent to a desired elevation angle.

8. The system for changing the elevation angle of a parabolic antenna of claim 1, wherein the worm gear comprises a slewing ring.

9. The system for changing the elevation angle of a parabolic antenna of claim 1, wherein the first gear set is self locking.

10. The system for changing the elevation angle of a parabolic antenna of claim 1, wherein the first rotational motion source comprises a motor.

11. The system for changing the elevation angle of a parabolic antenna of claim 1, the system further comprising a housing, wherein at least a portion of the first gear set is enclosed in the housing.

12. The system for changing the elevation angle of a parabolic antenna of claim 1, the system further comprising a bearing, wherein at least some portion of the bearing is configured to rotate about the substantially horizontal axis, and wherein the parabolic antenna and the support member are operably coupled with the bearing.

13. A method for changing the elevation angle of a parabolic antenna, the method comprising:
providing a first gear set operably coupled with a support member and the parabolic antenna, wherein:
the first gear set comprises a worm gear and a first worm;
the first worm engages the worm gear;
the worm gear has a substantially horizontal axis; and
the support member and the parabolic antenna are operably coupled with the first gear set;
providing a first rotational motion source, wherein the first rotational motion source is operably coupled with the first worm;
activating the first rotational motion source to generate a first rotational motion; and
receiving the first rotational motion with the first worm to rotate the parabolic antenna about the substantially horizontal axis.

14. The method for changing the elevation angle of a parabolic antenna of claim 13, wherein:
the parabolic antenna being operably coupled with the first gear set comprises the parabolic antenna coupled with the worm gear;
the worm gear is configured to rotate about the substantially horizontal axis; and
the first worm is configured to transfer rotational motion with the worm gear.

15. The method for changing the elevation angle of a parabolic antenna of claim 13, wherein:
the support member being operably coupled with the first gear set comprises the support member coupled with the worm gear;
the first worm comprises a rotational axis; and
the first worm is configured to revolve around the substantially horizontal axis when the first worm rotates about the rotational axis.

16. The method for changing the elevation angle of a parabolic antenna of claim 13, the method further comprising:
providing a second gear set; and
changing the speed of the first rotational motion received by the first worm with the second gear set.

17. The method for changing the elevation angle of a parabolic antenna of claim 13, wherein the first gear set further comprises a second worm which engages the worm gear, and the method further comprises:
providing a second rotational motion source, wherein the second rotational motion source is operably coupled with the second worm;
activating the second rotational motion source to generate a second rotational motion; and
receiving the second rotational motion with the second worm to rotate the parabolic antenna about the substantially horizontal axis.

18. The method for changing the elevation angle of a parabolic antenna of claim 17, wherein the first rotational motion and the second rotational motion are each configured to at least attempt to rotate parabolic antenna in opposite directions for a period of time to substantially lock the worm gear in relation to the first worm and the second worm.

19. The method for changing the elevation angle of a parabolic antenna of claim 13, the method further comprising:
determining an approximate elevation angle of the parabolic antenna; and
activating the first rotational motion source until the approximate elevation angle is substantial equivalent to a desired elevation angle.

20. A machine-readable medium having machine executable instructions for changing the elevation angle of a parabolic antenna, wherein the machine-readable medium comprises machine-executable instructions for:
activating a first rotational motion source to generate a first rotational motion, wherein:
the first rotational motion source is operably coupled with a first gear set comprising a first worm engaging a worm gear;
the first gear set is operably coupled with a parabolic antenna; and
the parabolic antenna rotates about a substantially horizontal axis when the first rotational motion source is active; and
deactivating the first rotational motion source.

21. The machine-readable medium having machine executable instructions for changing the elevation angle of a parabolic antenna of claim 20, wherein the first gear set being operably coupled with the parabolic antenna comprises the parabolic antenna coupled with the worm gear.

22. The machine-readable medium having machine executable instructions for changing the elevation angle of a parabolic antenna of claim 20, wherein the first gear set being operably coupled with the parabolic antenna comprises a support member coupled with the worm gear.

23. The machine-readable medium having machine executable instructions for changing the elevation angle of a parabolic antenna of claim 20, the machine-readable medium further comprising machine-executable instructions for:
activating a second rotational motion source to generate a second rotational motion, wherein:
the first gear set further comprises a second worm engaging the worm gear; and
the second rotational motion source is operably coupled with the second worm; and
deactivating the second rotational motion source.

24. The machine-readable medium having machine executable instructions for changing the elevation angle of a parabolic antenna of claim 23, the machine-readable medium further comprising machine-executable instructions for:
activating the first rotational motion source to at least attempt to rotate the parabolic antenna in a first rotational direction;
activating the second rotational motion source to at least attempt to rotate the parabolic antenna in a second rotational direction, wherein the second rotational direction is opposite the first rotational direction; and
deactivating the first rotation motion source and the second rotational motion source when the worm gear is substantially locked in relation to the first worm and the second worm.

25. The machine-readable medium having machine executable instructions for changing the elevation angle of a parabolic antenna of claim 20, the machine-readable medium further comprising machine-executable instructions for:
receiving a signal from a sensing mechanism;
determining an approximate elevation angle of the parabolic antenna based at least in part on the signal; and
activating the first rotational motion source in either rotational direction until the approximate elevation angle is substantial equivalent to a desired elevation angle.
